(19) United States
(12) Patent Application Publication
(10) Pub. No.: US 2018/0073235 A1
(43) Pub. Date: Mar. 15, 2018

(54) GASKET SYSTEM AND METHODS OF USE

(71) Applicant: FLUIDMASTER, INC., San Juan Capistrano, CA (US)

(72) Inventors: DANIEL MCFARLAND, San Juan Capistrano, CA (US); TUAN LE, Fountain Valley, CA (US)

(21) Appl. No.: 15/701,281

(22) Filed: Sep. 11, 2017

Related U.S. Application Data
(60) Provisional application No. 62/472,413, filed on Mar. 16, 2017.
(60) Provisional application No. 62/385,939, filed on Sep. 9, 2016.

(51) Int. Cl. E03D 11/13; E03D 3/02; F16K 21/00

(52) U.S. Cl. CPC E03D 11/13; F16K 21/00; E03D 3/02

(57) ABSTRACT

Embodiments of the invention provide a gasket for a fluidic seal. Some embodiments include a flush valve to a toilet tank, where the gasket has a raised center portion and lowered inner and outer portions. In some embodiments, the gasket includes a plurality of recesses, troughs or grooves. Each of the three portions of the gasket has a bottom groove that can permit deformation and increases sealing capabilities when the groove either widens or narrows. Additionally, some embodiments include an inner support ring that extends inwardly from the lowered inner portion, and can center the gasket onto the flush valve.

### RELATED APPLICATIONS

This application claims priority to U.S. provisional application Ser. No. 62/385,939 entitled “TANK TO VALVE GASKET”, filed on Sep. 9, 2016, and to U.S. provisional application Ser. No. 62/472,413 entitled “TANK GASKET”, filed on Mar. 16, 2017, the entire contents of which are incorporated herein by reference.

### BACKGROUND

Flush valves are typically secured into place in fluid tanks (e.g., toilet tanks) by gaskets. Unfortunately, many traditional gaskets tend to leak and do not provide a sufficiently strong long term seal between the flush valve and the tank. These same problems occur when sealing other valves to other sorts of tanks. It would instead be desirable to provide an improved sealing gasket for uses with flush valves (e.g., such as toilet flush valves) or other flush valves. In particular, it would also be desirable to provide a sealing gasket with improved accommodation of holes of different sizes, improved accommodation of holes of different roundness and surface finishes, and improved accommodation of tanks bottoms having different surface flatness.

### SUMMARY

Some embodiments include a gasket body comprising a raised center portion extending from one side portion of the gasket body, a lowered outer portion and a lowered inner portion separated by a trough. In some embodiments, the trough is formed in an opposite side portion of the gasket body opposite to the one side portion. Some embodiments include an inwardly extending inner support ring, and a groove in an opposite side portion of the gasket body opposite to the one side portion.

In some embodiments, the lowered inner portion and lowered outer portion each have grooves. In some further embodiments, the raised center portion has a flattened top. In some embodiments, the gasket body is circular. Some further embodiments include a gasket bottom surface of the lowered outer portion that is positioned further from the flattened top than a bottom surface of the lowered inner portion.

In some embodiments of the invention, at least one of the grooves is configured and arranged to narrow as the raised center portion widens when the gasket is compressed. In some further embodiments, the raised center portion is configured and arranged to widen and at least one of the grooves in the lowered inner and outer portions is configured and arranged to narrow when the gasket is compressed.

In some embodiments, the gasket is configured to be positioned under a flush valve and on top of a hole in the bottom of a fluid tank, where the gasket forms a fluid seal between an interior and exterior of the tank by compression and deformation the raised center portion, the bottom groove, the lowered inner portion, and/or the lowered outer portion.

Some embodiments include a circular gasket body encircling an aperture comprising a raised center portion on one side portion of the gasket body and a trough on an opposite side portion of the gasket body. Some embodiments include a lowered outer portion extending away from the aperture on one side of the trough, and a lowered inner portion extending towards the aperture on an opposite side of the trough. Further, some embodiments include at least one first groove configured and arranged to narrow when the gasket is compressed, and at least one second groove configured and arranged to widen as the at least one first groove narrows.

In some embodiments, the at least one first groove or the at least one second groove is positioned extending through the bottom surface of the lowered outer portion. In other embodiments, the at least one first groove or the at least one second groove is positioned extending through the bottom surface of the lowered inner portion.

Some embodiments include a third groove positioned in the trough. In some embodiments, the third groove is configured and arranged to widen when the gasket is compressed. In some embodiments, the third groove is configured and arranged to widen and the first and second grooves narrow under a first compressive load, and the third groove widens further and the first and second grooves narrow further under a second compressive load that is greater than the first load.

In some embodiments, at least a portion of the gasket within the trough or adjacent to the trough is configured to deform or spread over a surface forming a seal during application of at least one of the first compressive load or the second compressive load. In some embodiments, the deformation or spread over a surface is controlled or guided by at least of portion of the gasket body translating deformation or spread of an adjacent or coupled portion of the gasket body. In some embodiments, the lowered outer portion is configured and arranged to extend upwards towards the raised center portion when the gasket is compressed.

Some further embodiments include an inner support ring coupled to the lowered inner portion. In some embodiments, at least a portion of the inner support ring is configured and arranged to extend upwards away from the trough when the gasket is compressed. In some other embodiments, the inner support ring comprises a surface generally parallel with a bottom surface of the lowered outer portion or lowered inner portion.

### DESCRIPTION OF THE DRAWINGS

FIG. 1A is a top perspective view of a gasket in accordance with some embodiments of the invention.

FIG. 1B is a bottom perspective view of a gasket in accordance with some embodiments of the invention.

FIG. 1C is a bottom-front perspective view of a gasket in accordance with some embodiments of the invention.

FIG. 1D is a top-front perspective view in accordance with some embodiments of the invention.

FIG. 2A is a cross-sectional view of a portion of a gasket in accordance with some embodiments of the invention.

FIG. 2B is a close-up cross-sectional view of the gasket of FIG. 2A in accordance with some embodiments of the invention.

FIG. 2C is an inverted view of the cross-sectional view of FIG. 2B in accordance with some embodiments of the invention.

FIG. 3A is a close-up cross-sectional view of a gasket in accordance with some further embodiments of the invention.

FIG. 3B is a representation of a compression of the gasket of FIG. 3A in accordance with some embodiments of the invention.

FIG. 4A is a representation of a cross-section of a gasket prior to loading and compression in accordance with some embodiments of the invention.

FIG. 4B is a representation of a compressed cross-section of the gasket of FIG. 4A after loading with a 1 mm displacement as load in accordance with some embodiments of the invention.

FIG. 4C is a perspective view the compressed gasket of FIG. 4A after loading with a 1 mm displacement as load in accordance with some embodiments of the invention.

FIG. 5A is a representation of a compressed cross-section of the gasket of FIG. 4A after loading with a 2 mm displacement as load in accordance with some embodiments of the invention.

FIG. 5B is a perspective view the compressed gasket of FIG. 4A after loading with a 2 mm displacement as load in accordance with some embodiments of the invention.

FIG. 6A is a representation of a compressed cross-section of the gasket of FIG. 4A after loading with a 3 mm displacement as load in accordance with some embodiments of the invention.

FIG. 6B is a perspective view the compressed gasket of FIG. 4A after loading with a 3 mm displacement as load in accordance with some embodiments of the invention.

FIG. 7A is a representation of a compressed cross-section of the gasket of FIG. 4A after loading with a 4 mm displacement as load in accordance with some embodiments of the invention.

FIG. 7B is a perspective view the compressed gasket of FIG. 4A after loading with a 4 mm displacement as load in accordance with some embodiments of the invention.

FIG. 8A is a representation of a compressed cross-section of the gasket of FIG. 4A after loading with a 5 mm displacement as load in accordance with some embodiments of the invention.

FIG. 8B is a perspective view the compressed gasket of FIG. 4A after loading with a 5 mm displacement as load in accordance with some embodiments of the invention.

FIG. 9A is a representation of a compressed cross-section of the gasket of FIG. 4A after loading with a 6 mm displacement as load in accordance with some embodiments of the invention.

FIG. 9B is a perspective view the compressed gasket of FIG. 4A after loading with a 6 mm displacement as load in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments of the invention described herein relate to gaskets for sealing flush valves or any other type of valve onto a tank. Some embodiments include gaskets related to sealing toilet flush valves onto toilet tanks. Some embodiments include a gasket that can be used for applications including sealing a flush valve to the bottom of a toilet tank. However, one of ordinary skill in the art will recognize that at least one or more of the embodiments described herein can be used in other applications requiring a seal between two fluidly coupled orifices. For example, in some embodiments, one or more of the embodiments described herein can be used to seal a fluidic coupling between a fluid carrying pipe and a fluid storage or holding tank. In other embodiments, one or more of the embodiments described herein can be used to seal a fluidic coupling between two or more fluid carrying pipes.

Some embodiments include a gasket including a structure that can comprise at least one raised center portion. Some embodiments include a gasket including a structure that can comprise at least one lowered inner portion. Some embodiments include a gasket including a structure that can comprise at least one lowered outer portion. Some embodiments include a gasket including a structure that can comprise at least one raised center portion. In one non-limiting example embodiment, a gasket embodiment can comprise a generally upside down V-shaped cross-section with a structure formed from a structure comprising a raised center portion and lowered inner and outer portions.

In some embodiments, when used to provide a seal between one or more fluidic components (e.g., such as those described earlier), the gasket can become compressed from above by one or more fluidic components (e.g., such as a flush valve). In some embodiments, the gasket can form a seal between fluidic components by being compressed from above and below (e.g., from a top side and a bottom side) by one or more fluidic components (e.g., such as a flush valve). In some embodiments, at least a portion of the gasket can deform such that at least some portions spread outwardly across at least one interface (e.g., a surface of at least one component or assembly) coupled to the gasket. In some embodiments, at least a portion of the gasket can deform so that any lowered inner and outer portions can spread outwardly (e.g., across the bottom surface of the toilet tank).

Some embodiments include one or more grooves or channels that can permit specific deformation of the gasket in a way that increases its ability to form a seal. For example, some embodiments include one or more raised portions of the gasket that include one or more grooves or channels that can permit specific deformation of the gasket in a way that increases its sealing properties. Further, other embodiments include one or more lowered portions of the gasket that can include one or more grooves, recesses, troughs, or channels that can permit specific deformation of the gasket in a way that increases its ability to seal against one or more surfaces and/or to form a seal between a surface and at least one other surface. For example, some embodiments include grooves that can allow at least a portion of the bottom surface of the gasket to deform to match the bottom surface of a fluidic tank (e.g., such as a toilet tank), while the grooves in the lower portions of the gasket are pushed slightly together when the gasket is deformed. Further, in some embodiments, when at least a portion of the gasket is deformed, at least a portion of the gasket (e.g., such as a raised center portion) can spread apart, thereby allowing the gasket to widen. Further, in embodiments with a groove, recess, or trough running along the bottom of the raised center portion, this structure can assist with the deformation spreading and can enable a sliding or other movement with respect to structures to be sealed.

Some embodiments of the gasket can include extensions, flanges, and/or rings that can assist, augment, and/or take part in at least a portion of the deformation and spreading of the gasket. Some embodiments include an inner support ring that can extend inwardly. For example, some embodiments include an inner support ring that can extend inwardly from the lowered inner portion. In some embodiments, this inner support ring can help to center the gasket onto a surface, component or assembly (e.g., such as a flush valve). Some embodiments include a gasket that can include some portions on one side that can be lower than other portions. For example, in at least one non-limiting embodiment, a gasket can include a lowered outer portion that can be lower than the bottom of the lowered inner portion. In this instance, a significant portion of the sealing can be accomplished by the outer lowered portion.

Some embodiments of the invention can accommodate holes or apertures in fluidic surfaces that have been punched from below where the area immediately adjacent to the hole or aperture is deformed slightly upward. In some embodiments, having one or more portions and/or surfaces of the gasket that are lower that other portions in one or more sides can enable the gasket to accommodate uneven or deformed surfaces. For example, as described further below, having the bottom of a lowered outer portion lower than the bottom of a lowered inner portion can be conducive to forming a seal onto or between deformed, uneven, or rough surfaces.

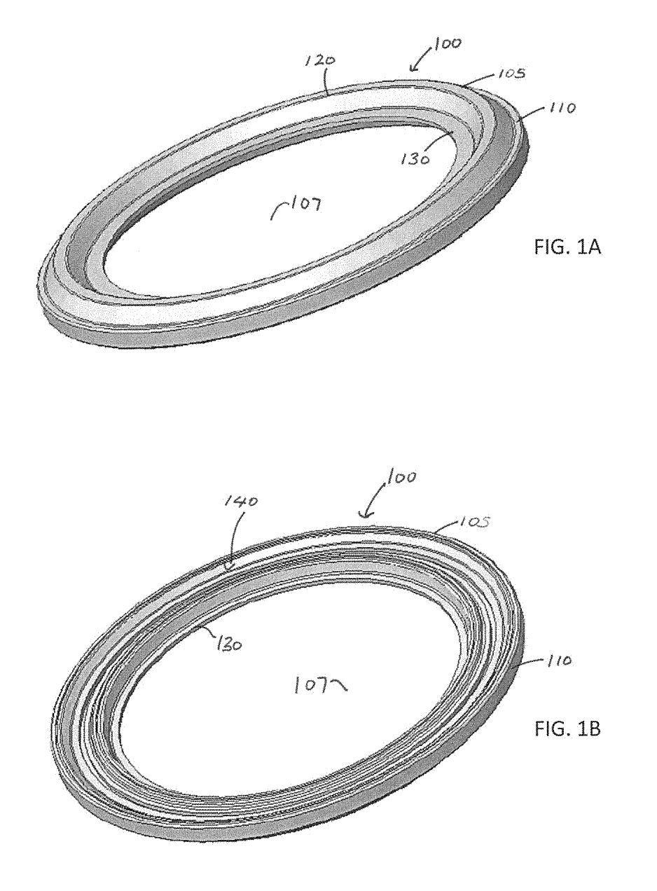

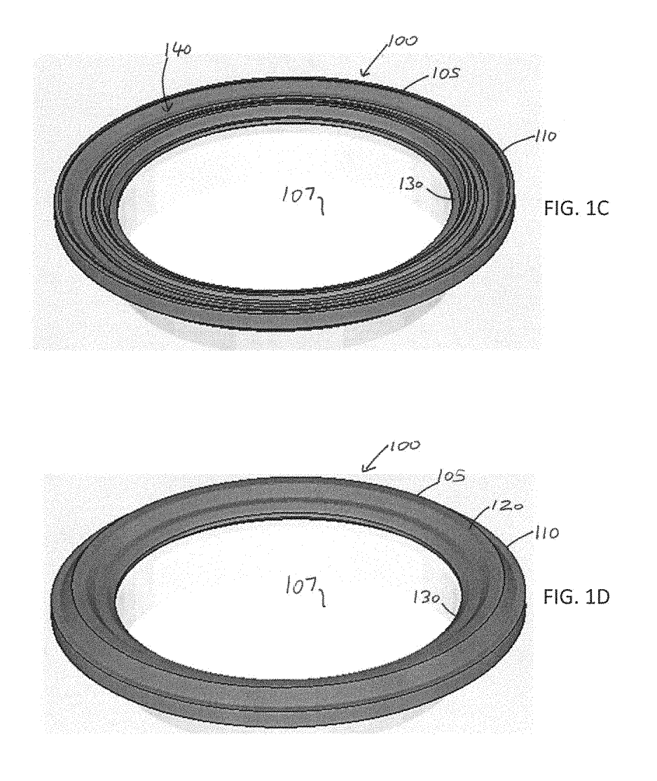

The various features and functions of the aforementioned gasket are shown in one or more of the FIGS. 1A-1D, 2A-2C, 3A-3B, 4A-4C, 5A-5B, 6A-6B, 7A-7B, 8A-8B, and 9A-9B and described in more detail below. For example, in reference to FIGS. 1A-1D, some embodiments include a generally circular gasket (i.e., O-ring shaped gasket) including at least some of the features, structures, and/or functions described above. For example, FIG. 1A is a top perspective view of a gasket 100, and FIG. 1B is a bottom perspective view of the gasket 100 in accordance with some embodiments of the invention. Further, FIG. 1C is a bottom-front perspective view of the gasket 100, and FIG. 1D is a top-front perspective view of the gasket 100 in accordance with some embodiments of the invention. As illustrated in the non-limiting embodiment of FIGS. 1A-1D, the gasket 100 can be formed from a gasket body 105 comprising raised and lowered portions, rings or flanges, and grooves or channels. The gasket body 105 can include a generally circular shape encircling an aperture 107 where the gasket body 105 includes at least some of the features, structures, and/or functions described above. For example, some embodiments of the gasket 100 or variations of the gasket 100 can comprise a gasket body 105 or variation of the gasket body 105 with at least some of the raised and lowered portions, rings or flanges, and grooves, recesses, troughs, or channels that can control or guide any movement or deformation of the gasket during uniaxial compression or multiaxial compression (e.g., biaxial compression). In some embodiments, any resulting compressive displacement of any portion of the gasket can be along a single axis or multiple axes with accompanying change in direction. In some embodiments, gasket body 105 can be formed as a linear or straight gasket structure. Alternatively, in some further embodiments, the gasket body 105 can comprise linear or straight in combination with bent or curved portions.

In reference to FIGS. 1A and 1D, in some embodiments, the gasket body 105 can comprise a raised center portion 120 extending from a top side of the gasket body 105 coupled to an inwardly extending inner support ring 130 and an outwardly extending lowered outer portion 110. The raised center portion 120 is shown extending circularly around the gasket body 105, the inner support ring 130 is shown extending around the inner circumference of the gasket body 105, and the outwardly extending lowered outer portion 110 is shown extending around the outer circumference of the gasket body 105. In some alternative embodiments (not shown), one or more of the raised center portion 120, the inner support ring 130, and/or the outwardly extending lowered outer portion 110 may not extend completely around the circular gasket body 105.

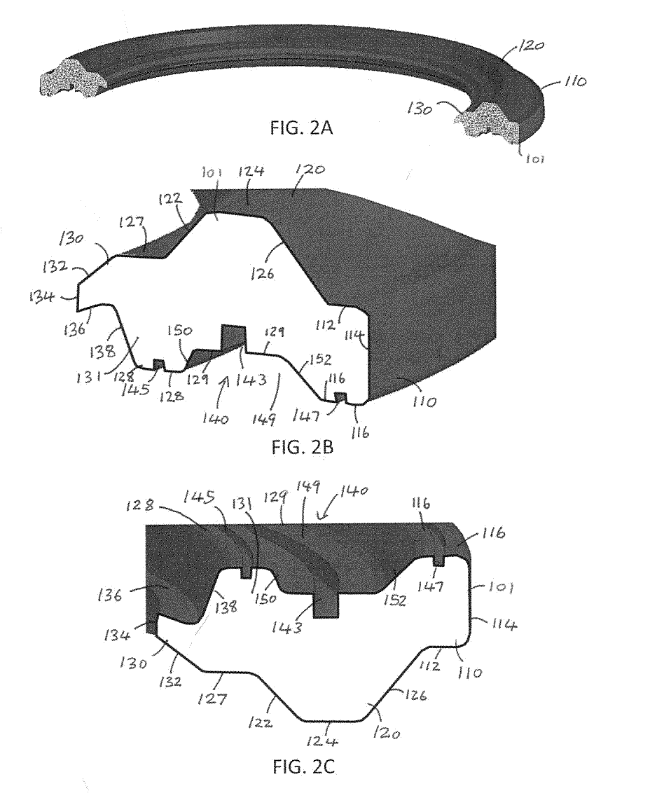

In further reference to FIGS. 1B and 1C, in some embodiments, the side of the gasket opposite the top side of the gasket body 105 (herein called the bottom side) can comprise a plurality of grooves 140. In reference to FIG. 2A, showing a cross-sectional view of a portion of a gasket 100 in accordance with some embodiments of the invention, inner support ring 130, outer portion 110, raised center portion 120, and grooves 140 can form a cross-sectional shape 101 when free-standing (i.e., in an uncompressed state). The grooves 140 and further structural details of the gasket 100 with cross-sectional shape 101 are discussed further below in reference to FIGS. 2B and 2C.

In some embodiments, the raised center portion 120 can include a flattened top 124 extending between an inner face 122 positioned extending towards the aperture 107, and an outer face 126 extending away from the aperture 107 from the flattened top 124 towards the lowered outer portion 110. In some embodiments, the gasket body 105 can include a lower ledge 112 extending between the outer face 126 and an outer edge surface 114 of the lowered outer portion 110. Further, some embodiments include an upper ledge 127 extending from the inner face 122 towards the aperture 107. In some embodiments, the lower and upper ledges 112, 127 can extend the length of the gasket body 105.

In some embodiments of the invention, the inner support ring 130 can comprise an inner surface 132 extending from the upper ledge 127 towards the aperture 107. In some embodiments, the inner surface 132 can couple to an inner edge surface 134. In some embodiments, the inner edge surface 134 and the aforementioned outer edge surface 114 can be substantially parallel as shown. In some other embodiments, the inner edge surface 134 and the aforementioned outer edge surface 114 can be non-parallel. For example, in some embodiments, the inner edge surface 134 and/or the outer edge surface 114 can be sloped away or towards the aperture 107.

In some embodiments, a bottom surface 136 can extend from the inner edge surface 134 away from the aperture 107. In some embodiments, the inner support ring 130 can extend inwardly from a lowered inner portion 131. Further, the bottom surface 136 can couple with bottom side surface 138 forming the inward side of the inner portion 131. In some embodiments, the lowered outer portion 110 and lowered inner portion 131 can include bottom surfaces separated by a trough 149. For example, in some embodiments, the lowered outer portion 110 can comprise a bottom surface 116 extending inwardly towards the trough 149 from the outer edge surface 114. Further, in some embodiments, the lowered inner portion 131 can include bottom surface 128 extending from the bottom side surface 138 towards the trough 149. In some embodiments, the trough 149 can be positioned extending inwards on one side (e.g., the bottom side) of the gasket 100 towards the raised center portion 120 on an opposite side (i.e., the top side) of the gasket 100.

In some embodiments, the trough 149 is bounded by inner side surfaces 150, 152 that extend from their respective bottom surfaces of the lowered outer and inner portions 110, 130. For example, in some embodiments, the inner side surface 150 can extend from the bottom surface 128 to couple with an inner side surface 150 of the trough 149. Further, in some embodiments, the bottom surface 116 can extend inwardly to couple with the inner side surface 152 of the trough 149. As shown, in some embodiments, the bottom surfaces 116, 128 can be substantially parallel with each other. In other embodiments, the bottom surfaces 116, 128 can be substantially non-parallel with each other. Further, in some embodiments, as the lowered outer portion 110 extends further from the flattened top 124 than lowered inner portion 131, the bottom surface 116 can be positioned further away from the flattened top 124 than the bottom surface 128. In other words, in some embodiments, the bottom surfaces 116, 128 do not lie in the same plane. In some other embodiments (not shown), the lowered outer portion 110 can extend the same distance from the flattened top 124 than lowered inner portion 131, and therefore the bottom surfaces 116, 128 can lie generally within the same plane. In some further embodiments (not shown), the lowered outer portion 110 can extend a greater distance from the flattened top 124 than lowered inner portion 131, where the bottom surfaces 116, 128 do not lie in the same plane.

As described earlier, some embodiments include grooves 140 of the gasket body 105 that can permit specific deformation of the gasket in a way that increases its ability to form a seal. In some embodiments, any one or both of the lower outer or lowered inner portions 110, 131 can include one or more grooves. For example, as illustrated in FIGS. 2B, 2C, where FIG. 2B is a close-up cross-sectional view of the gasket 100 of FIG. 2A, and FIG. 2C is an inverted view of the cross-sectional view of FIG. 2B in accordance with some embodiments of the invention, some embodiments include a bottom groove 147 positioned in the lowered outer portion 110, and a bottom groove 145 positioned in the lowered outer portion 110. In some embodiments, bottom groove 145 and/or bottom groove 147 can extend the circular length of the gasket body 105. In other embodiments (not shown) the bottom groove 145 and/or bottom groove 147 can extend a partial or incomplete circular length of the gasket body 105.

In some embodiments, trough 149 can include at least one groove. For example, in some embodiments, the gasket body 105 can include a bottom groove 143 positioned extending through the inner center surface 129, with the inner center surface extending between the inner side surfaces 150, 152. In some embodiments, the bottom groove 143 can include a radial diameter that is greater than the radial diameter of either or both of the bottom surfaces 145, 147. In some embodiments (not shown), the bottom groove 143 includes a radial diameter that is the same as either or both of the bottom surfaces 145, 147. In some further embodiments, the bottom surfaces 145, 147 comprise a radial diameter than is substantially the same. In other embodiments (not shown), the bottom surfaces 145, 147 comprise different radial diameters.

In some embodiments, the bottom groove 143 can be positioned extending through the inner center surface 129 so that the distance between the bottom groove 143 and the inner side surface 150 is less than the distance between the bottom groove 143 and the inner side surface 152. In other embodiments (not shown), the bottom groove 143 can be positioned extending through the inner center surface 129 so that the distance between the bottom groove 143 and the inner side surface 152 is less than the distance between the bottom groove 143 and the inner side surface 150. Further, in some other embodiments, the bottom groove 143 can be positioned extending through the inner center surface 129 so that the distance between the bottom groove 143 and the inner side surfaces 150, 152 is substantially the same (i.e., the bottom groove 143 is positioned equidistant between the inner side surfaces 150, 152).

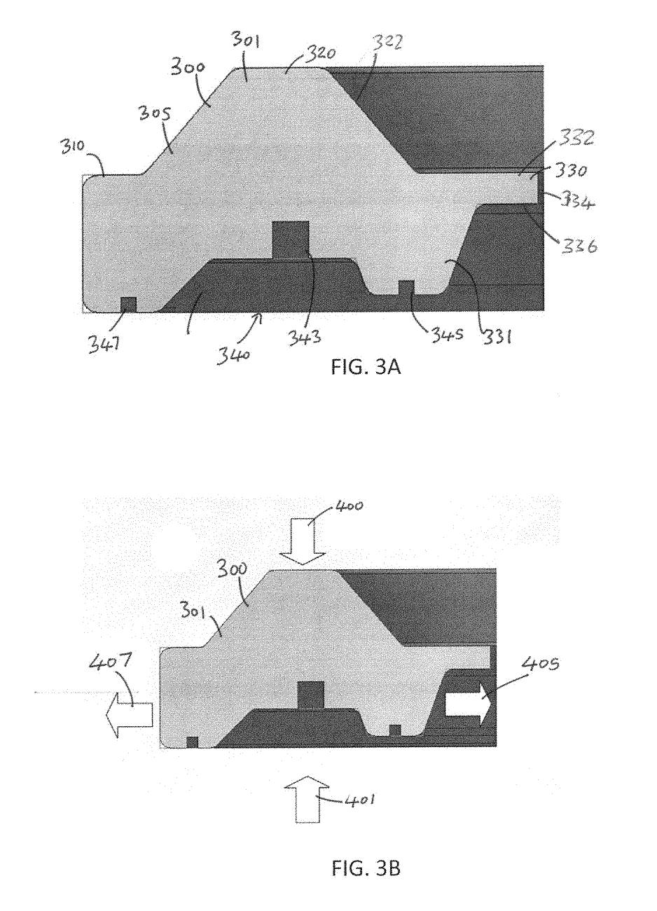

In some embodiments, the gasket 100 can include variations in the structure and shape of the inner support ring 130. For example, some embodiments can include a gasket 300 that comprises substantially the same structure and shape of gasket 100 except for portions including the inner support ring 130 and/or adjacent structure. For example, FIG. 3A is a close-up cross-sectional view of a gasket 300 with cross-sectional shape 301, and shows the inner support ring 330 that can comprise an inner face 332 extending between the inner face 322 that is coupled to the raised center portion 320, and the inner edge surface 334 of the inner support ring 330. In this non-limiting embodiment, the inner support ring 130 is characterized by a generally rectangular shape that includes bottom surface 336 that extends away from the inner edge surface 334 opposite and generally parallel to the inner face 332 towards the lowered inner portion 331. In some embodiments, the remaining structure and shape of the gasket body 305 can be substantially the same as the gasket body 105, including lowered outer portion 310, a plurality of grooves 340, including grooves 347, 345, and groove 343 positioned in trough 349 formed between the lowered inner and outer portions 331, 310.

As described earlier, some applications include applying a compressive force to a gasket including any of the gasket embodiments described herein. As described earlier, as force is applied to one or more portions of the gasket, some deformation can occur causing movement of portions of the gasket. This process is represented in FIG. 3B showing a compression of the gasket 300 of FIG. 3A in accordance with some embodiments of the invention. The arrows shown include force from valve flange 400, force from a tank 401 and resultant inner deflection 405, and outer deflection 407.

Further, as described earlier, some specific grooves, recesses, troughs, or channels and related or coupled features can permit specific deformation of the gasket in a way that increases its ability to form a seal. For example, some features allow at least a portion of the bottom surface of a gasket implementing these features to deform to match the bottom surface of a tank. Further, any grooves, recesses or troughs in the gasket can be pushed together during the deformation process. Further, in some embodiments, during deformation, at least a portion of the gasket (e.g., such as a raised center portion) can spread apart, thereby allowing the gasket to widen. Further, in embodiments with a groove running along the bottom of the raised center portion (e.g., groove 143, 343), this structure can assist with the deformation spreading. Further, other extensions, flanges, and/or rings can facilitate and/or be included in the deformation and spreading process.

In some embodiments, any of the gasket structures described herein can be compressed within a fluid coupling by more or less than described herein and can form or maintain a seal between any substantially smooth and/or uneven or deformed interface. For example, in some embodiments, any of the gasket structures described herein can be used to form a seal between two structures following a compression of less than 1 mm displacement as load. In some other embodiments, any of the gasket structures described herein can be used to form a seal between two structures following a compression of more than 6 mm displacement as load. Further, any of the gasket structures described herein can be used to form a seal between two structures following a compression of more than 1 mm displacement as load and less than 6 mm displacement as load in any increments of distance between 1 mm and 6 mm.

In some embodiments, in some embodiments, any of the gasket structures described herein can be used to form a seal between two structures with more than one aperture. For example, in some embodiments, any of the gasket structures described herein can be used to form a seal by sealing over two or more apertures forming two or more fluidic couplings.

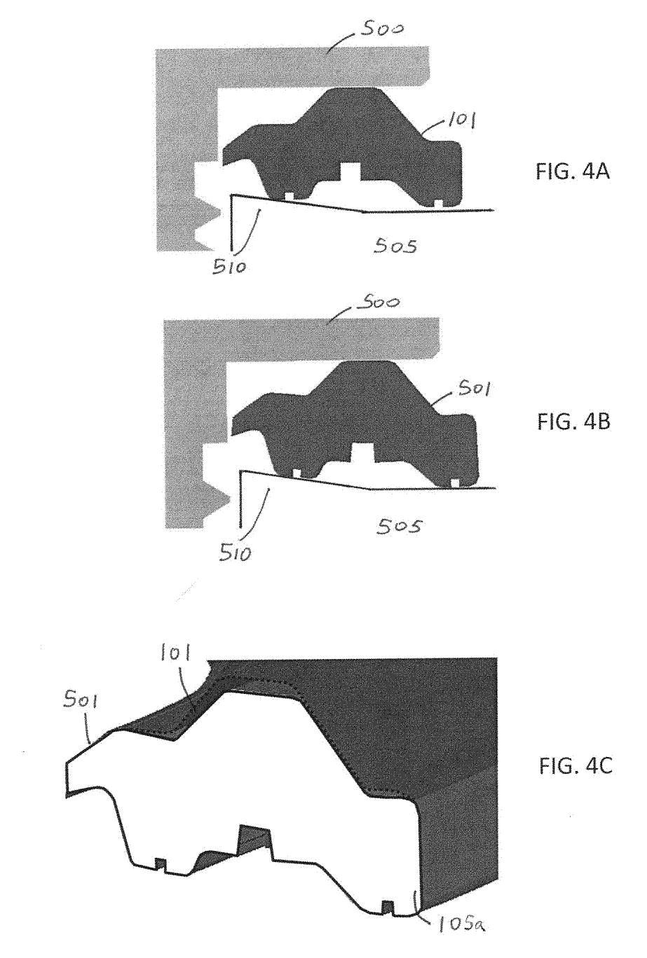

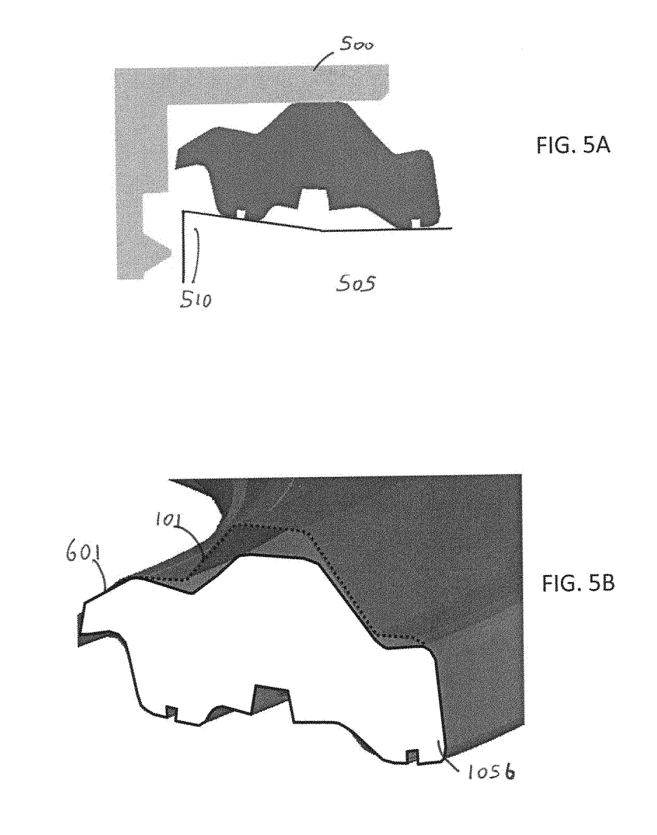

With reference to using the specific embodiment of gasket 100, and to FIGS. 4A-4C, 5A-5B, 6A-6B, 7A-7B, 8A-8B, and 9A-9B, the deformation behavior of the gasket body 105 is shown by illustrating the representative change in cross-sectional shape 101 under different loads (represented by displacement distance of flush valve 500 with respect to deformed regions 510 adjacent a hole formed in tank 505). For example, FIG. 4A is a representation of a cross-section of a gasket 100 prior to loading and compression with the cross-sectional shape 101 shown. FIG. 4B is a representation of a compressed cross-section of the gasket of FIG. 4A after loading with a 1 mm displacement as load in accordance with some embodiments of the invention. Following deformation, the resultant cross-sectional shape 501 of gasket body 105a (compressed body 105) is shown in comparison to the uncompressed cross-section (where a portion of the cross-sectional shape 101 shown in dotted line) in FIG. 4C. Further deformations can be seen for greater displacement distances (and thus compressive loads). For example, FIG. 5A is a representation of a compressed cross-section of the gasket of FIG. 4A after loading with a 2 mm displacement as load in accordance with some embodiments of the invention. The compressed gasket body 105b is shown further in FIG. 5B with its cross-sectional shape 601 shown in comparison to the uncompressed cross-section (cross-sectional shape 101 shown in dotted line).

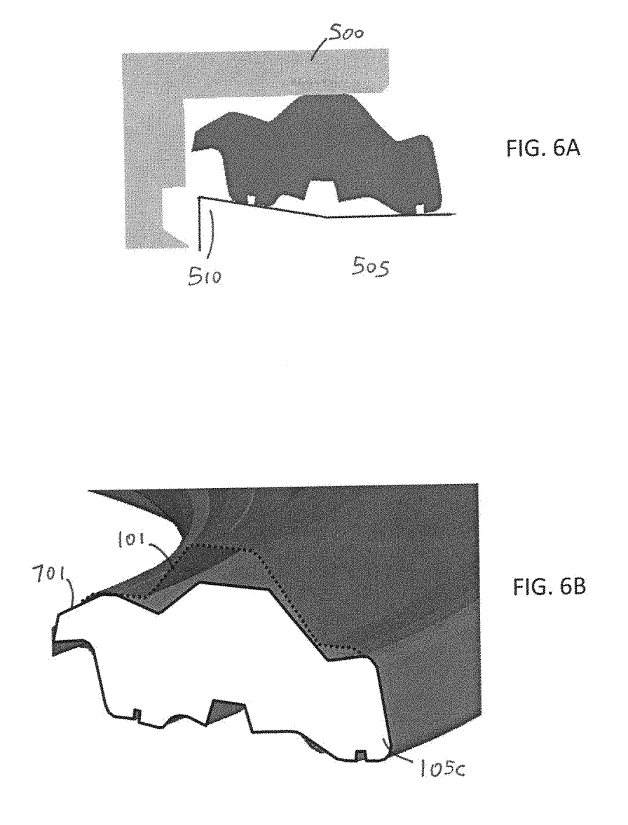

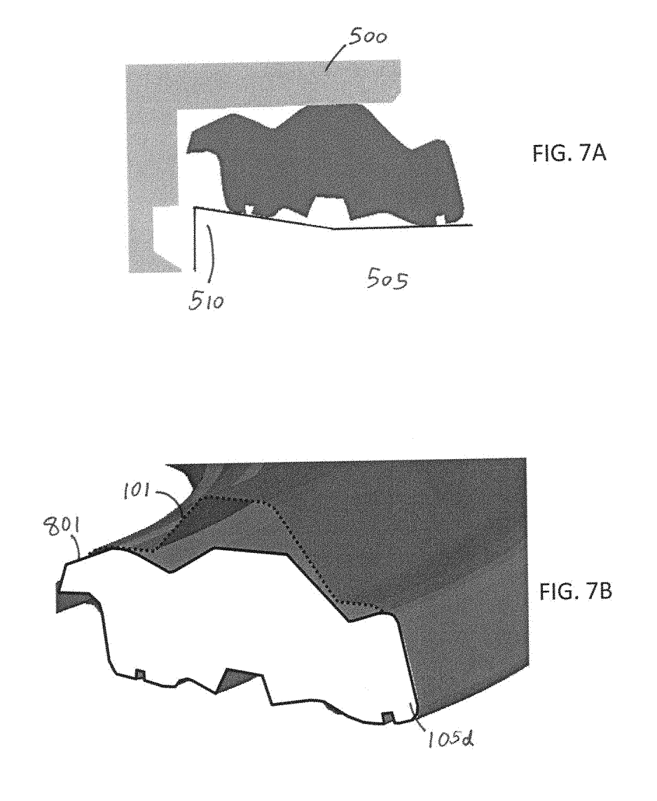

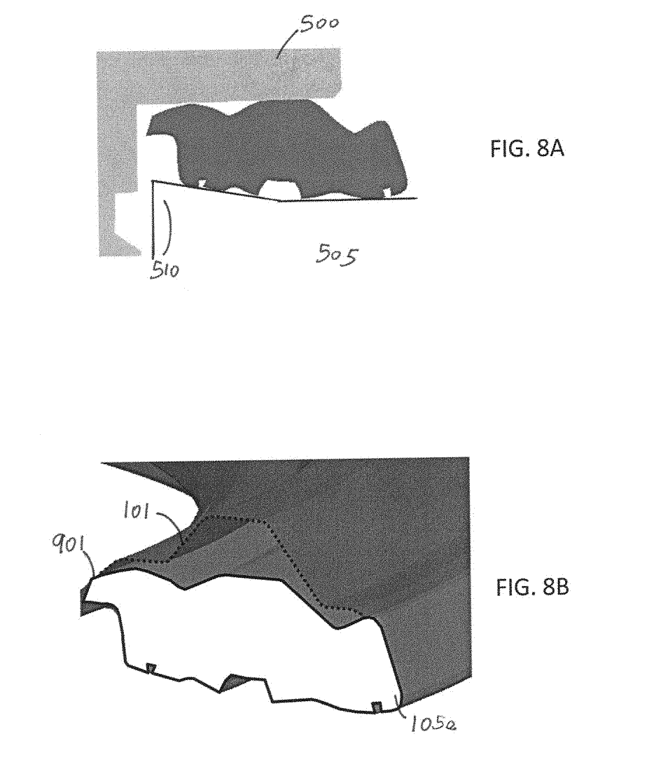

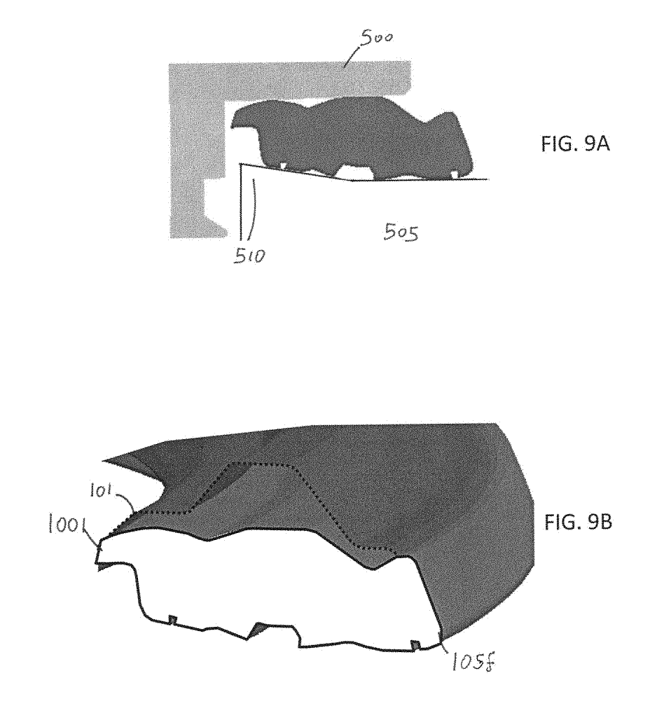

Further deformations can be seen for greater displacement distances. For example, FIG. 6A is a representation of a compressed cross-section of the gasket of FIG. 4A after loading with a 3 mm displacement as load in accordance with some embodiments of the invention. The compressed gasket body 105c is shown further in FIG. 6B with its cross-sectional shape 701 shown in comparison to the uncompressed cross-section (cross-sectional shape 101 shown in dotted line). Further, for example, FIG. 7A is a representation of a compressed cross-section of the gasket of FIG. 4A after loading with a 4 mm displacement as load in accordance with some embodiments of the invention. The compressed gasket body 105d is shown further in FIG. 7B with its cross-sectional shape 801 shown in comparison to the uncompressed cross-section (cross-sectional shape 101 shown in dotted line). Further, for example, FIG. 8A is a representation of a compressed cross-section of the gasket of FIG. 4A after loading with a 5 mm displacement as load in accordance with some embodiments of the invention. The compressed gasket body 105e is shown further in FIG. 8B with its cross-sectional shape 901 shown in comparison to the uncompressed cross-section (cross-sectional shape 101 shown in dotted line). Further for example, FIG. 9A is a representation of a compressed cross-section of the gasket of FIG. 4A after loading with a 6 mm displacement as load in accordance with some embodiments of the invention. The compressed gasket body 105f is shown further in FIG. 9B with its cross-sectional shape 1001 shown in comparison to the uncompressed cross-section (cross-sectional shape 101 shown in dotted line).

In some embodiments, any of the gasket structures described herein can be formed as shapes other than the circular gasket shown in FIGS. 1A-1B, and 1C-1D. For example, some embodiments comprise linear or straight gasket structures that have substantially the same or similar cross-sectional shape as the cross-sectional shape 101 as shown in FIGS. 2B and 2C, or alternatively, the cross-sectional shape 310 shown in FIG. 3A. Further, some other embodiments include linear or straight gasket structures that have substantially the same or similar cross-sectional shape as the cross-sectional shape 101 as shown in FIGS. 2B and 2C, or alternatively, the cross-sectional shape 310 shown in FIG. 3A that are coupled to bent or curved gasket structures or gasket portions that have substantially the same or similar cross-sectional shape as the cross-sectional shape 101 as shown in FIGS. 2B and 2C, or alternatively, the cross-sectional shape 310 shown in FIG. 3A.

As illustrated by viewing and comparing between the cross-sectional shapes 101, 501, 601, 701, 801, and 901 of compressed gasket bodies 105a, 105b, 105c, 105d, 105e, and 105f of FIGS. 4B, 4C, 5A, 5B, 6A, 6B, 7A, 7B, 8A, 8B, and 9A, 9B, and with the cross-sectional shape 101 of the gasket body 105, compression of the gasket 100 can include deformation and spreading of a plurality of portions of the gasket body 105. For example, the raised center portion 120 can become compressed (resulting in a lower and wider cross-sectional area), while the lowered inner and outer portions can spread outwards, and upwards (towards the top side or raised center portion 120). As illustrated in viewing of FIGS. 4A, 5A, 6A, 7A, 8A, and 9A, higher deformation levels can result in the bottom side of the gasket 100 having an increased surface area coupled to the deformed regions 510 of tank 505, where the trough 149 is at least partially compressed or collapsed and various bottom surfaces (e.g., such as bottom surfaces 116, 128 are formed against the deformed regions 510 to form at least a partial portion of the seal of the gasket 100 on the tank 505.

In some embodiments, as the gasket 100 is positioned between flush valve 500 and a tank bottom that can include deformed surface 510, the deformation of the gasket can be guided by the novel shape of gasket 100. Specifically, when pressed down by a flange on flush valve 500, the bottom groove 143 can widen. Further, in some embodiments, when pressed down by the flange of flush valve 500, the bottom grooves 147 and 145 can narrow. As a result, bottom grooves 147 and 145 can provide multiple edges that can operate to better allow the material of the gasket body 105 to provide a seal by rolling onto the surface of the tank 505, including any deformed surface 510. In some embodiments, one or both bottom grooves 147, 145 can narrow during compression based on a compression force and/or the surface texture, surface roughness or shape. In some embodiments, the raised center portion 120 can widen as one or both grooves 147, 145 narrows when the gasket is compressed.

In some embodiments of the invention, at least a portion of any of the gasket structures described herein can comprise a polymer-based material including one or more homopolymers, one or more copolymers, or mixtures thereof. In some embodiments, the material can comprise an elastomeric polymer such as rubber or silicone. In some embodiments, the rubber can be a natural rubber (e.g., such as natural gum rubber), a synthetic rubber, or combinations thereof. In some embodiments of the invention, the material can comprise a butyl or butylene rubber, ethylene propylene diene monomer (epdm) rubber, neoprene rubber, nitrile rubber, silicone rubber, a polyurethane rubber, a fluoro-silicone, chloroprene rubber, nitrile rubber, or combinations thereof. In some embodiments, the material can include recycled rubber. In some other embodiments, the materials can comprise a silicone sponge or foam or a polyurethane sponge or foam.

In some embodiments of the invention, at least a portion of the material of any of the gasket structures described herein can comprise a polymer-based matrix material including a dispersed secondary material. For example, some embodiments include a material that comprises one or more polymers infused with (or including a dispersion of) filler elements, filler compounds, and/or filler mixtures. For example, in some embodiments, at least a portion of the material can comprise a polymer-based matrix material including filaments or particles dispersed in a matrix to form a composite material. For example, some embodiments include a filler that can comprise a fibrous material. In some embodiments, at least a portion of the filler can be oriented in a preferred direction. In some other embodiments, the material can comprise a fiber-filled matrix material including natural or synthetic filaments dispersed in a matrix to form a fiber composite material. Some embodiments include a filler material at least partially dispersed through at least a portion of the material. In some embodiments, the filler material can be amorphous or crystalline, organic or inorganic material. In some other embodiments, the particle size of the filler material can be between 1-10 microns. In some other embodiments, at least some portion of the filler material can be sub-micron. In some other embodiments, at least a portion of the filler can comprise a nano-sized particle filler material.

In some embodiments, any of the gasket structures disclosed herein can be fabricated using hand cutting, die cutting, laser cutting, and water jet cutting, molding, injection molding, reaction injection molding, or combinations thereof. For example, in some embodiments, some or all of the portions and features of the gaskets 100, 300 can be can be fabricated using hand cutting, die cutting, laser cutting, and water jet cutting, molding, injection molding, reaction injection molding, or combinations thereof. For example, in some embodiments, the grooves 140, 340 and/or associated structure can be formed using hand cutting, die cutting, laser cutting, and water jet cutting, molding, injection molding, reaction injection molding, or combinations thereof.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent or publication cited herein is incorporated by reference, as if each such patent or publication were individually incorporated by reference herein. Various features and advantages of the invention are set forth in the following claims.

1. A gasket body comprising:
a raised center portion extending from one side portion of the gasket body;
a lowered outer portion and a lowered inner portion separated by a trough, the trough being formed in an opposite side portion of the gasket body opposite to the one side portion;
an inwardly extending inner support ring; and
a groove in an opposite side portion of the gasket body opposite to the one side portion.

2. The gasket body of claim 1, wherein the lowered inner portion and lowered outer portion each have grooves.

3. The gasket body of claim 1, wherein the raised center portion has a flattened top.

4. The gasket of claim 1, wherein the gasket body is circular.

5. The gasket of claim 3, wherein a bottom surface of the lowered outer portion is positioned further from the flattened top than a bottom surface of the lowered inner portion.

6. The gasket of claim 1, wherein at least one of the grooves is configured and arranged to narrow as the raised center portion widens when the gasket is compressed.

7. The gasket of claim 2, wherein the raised center portion is configured and arranged to widen and at least one of the grooves in the lowered inner and outer portions is configured and arranged to narrow when the gasket is compressed.

8. The gasket of claim 1, wherein the gasket is configured to be positioned under a flush valve and on top of a hole in the bottom of a fluid tank, the gasket forming a fluid seal between an interior and exterior of the tank by compression and deformation of at least one of the raised center portion, the bottom groove, the lowered inner portion, and the lowered outer portion.

9. A gasket comprising:
a circular gasket body encircling an aperture, the circular gasket body comprising:
a raised center portion on one side portion of the gasket body and a trough on an opposite side portion of the gasket body;
a lowered outer portion extending away from the aperture on one side of the trough, and a lowered inner portion extending towards the aperture on an opposite side of the trough;
at least one first groove configured and arranged to narrow when the gasket is compressed; and
at least one second groove configured and arranged to widen as the at least one first groove narrows.

10. The gasket of claim 9, wherein the at least one first groove or the at least one second groove is positioned extending through the bottom surface of the lowered outer portion.

11. The gasket of claim 9, wherein the at least one first groove or the at least one second groove is positioned extending through the bottom surface of the lowered inner portion.

12. The gasket of claim 9, further comprising a third groove positioned in the trough.

13. The gasket of claim 12, wherein the third groove is configured and arranged to widen when the gasket is compressed.

14. The gasket of claim 12, wherein the third groove is configured and arranged to widen and the first and second grooves narrow under a first compressive load, and the third groove widens further and the first and second grooves narrow further under a second compressive load that is greater than the first load.

15. The gasket of claim 14, wherein at least a portion of the gasket within the trough or adjacent to the trough is configured to deform or spread over a surface forming a seal during application of at least one of the first compressive load or the second compressive load.

16. The gasket of claim 15, wherein the deformation or spread over a surface is controlled or guided by at least of portion of the gasket body translating deformation or spread of an adjacent or coupled portion of the gasket body.

17. The gasket of claim 12, wherein the lowered outer portion is configured and arranged to extend upwards towards the raised center portion when the gasket is compressed.

18. The gasket of claim 12, further comprising an inner support ring coupled to the lowered inner portion.

19. The gasket of claim 18, wherein at least a portion of the inner support ring is configured and arranged to extend upwards away from the trough when the gasket is compressed.

20. The gasket of claim 18, wherein the inner support ring comprises a surface generally parallel with a bottom surface of the lowered outer portion or lowered inner portion.
